(19) United States
(12) Patent Application Publication
(10) Pub. No.: US 2014/0218354 A1
(43) Pub. Date: Aug. 7, 2014

(54) VIEW IMAGE PROVIDING DEVICE AND METHOD USING OMNIDIRECTIONAL IMAGE AND 3-DIMENSIONAL DATA

(71) Applicant: Electronics and Telecommunications Research Institute, Daejeon (KR)

(72) Inventors: Il Kyu PARK, Daejeon (KR); Young Mi CHA, Busan (KR); Chang Woo CHU, Daejeon (KR); Jae Hean KIM, Yongin-si (KR); Jin Sung CHOI, Daejeon (KR); Bon Ki KOO, Daejeon (KR)

(73) Assignee: Electronics and Telecommunications Research Institute, Daejeon (KR)

(21) Appl. No.: 14/102,905

(22) Filed: Dec. 11, 2013

(30) Foreign Application Priority Data
Feb. 6, 2013 (KR) 10-2013-0013536

(51) Int. Cl. G06T 15/00

(52) U.S. Cl. CPC G06T 15/00
USPC 345/419

(57) ABSTRACT

A view image providing device and method are provided. The view image providing device may include a panorama image generation unit to generate a panorama image using a cube map including a margin area by obtaining an omnidirectional image, a mesh information generation unit to generate 3-dimensional (3D) mesh information that uses the panorama image as a texture by obtaining 3D data, and a user data rendering unit to render the panorama image and the mesh information into user data according to a position and direction input by a user.

### CROSS-REFERENCE TO RELATED APPLICATION

This application claims the benefit of Korean Patent Application No. 10-2013-0013536, filed on Feb. 6, 2013, in the Korean Intellectual Property Office, the disclosure of which is incorporated herein by reference.

### BACKGROUND

1. Field

The present invention relates to a view image providing device and method, and more particularly, to a view image providing device and method that renders an image seen from a predetermined view according to a user operation and provides the rendered image to the user.

2. Description of Related Art

A street view service shows an image of a user selected spot on a map to a user. The user may obtain a desired image by adjusting an image to a position and a direction of a desired view through a user interface (UI). Recently, through an inside building view service, an inside of a building may be shown remotely and a movement and view change within the building are enabled as if in a virtual space.

The street view service or the inside building view service stores omnidirectional panorama images taken by moving through a service object region by car or by walk and photographing positions, and transmits necessary panorama images to a user terminal when the user uses the service. The user terminal provides the service by outputting the transmitted panorama images according to a position and a view of the user.

In general, the street view service and the inside building view service provide the user with the service using omnidirectional images taken at constant periods. When a view position is changed, the street view service and the inside building view service are provided in a manner of jumping to a next omnidirectional image position rather than continuously moving. When the view position is changed in the jumping manner, the street view service and the inside building view service may provide a smooth movement animation by inserting animation between the jumped views.

An image seen from an actual photographing position may be converted into the omnidirectional image. However, when the view position is changed, a virtual image may not be generated using only the omnidirectional images. Therefore, 3-dimensional (3D) position information around the view is additionally provided to the image.

Accordingly, there is a demand for a method of obtaining 3D position information of surroundings and rendering using the 3D position information when using the street view service which randomly changes the view position or when producing animation by generating an image of an intermediate position between changed views.

### SUMMARY

An aspect of the present invention provides a view image providing device and method capable of providing a view image smoothly and ceaselessly to a user when providing a service according to a user operation, by rendering an image of a predetermined view using an omnidirectional image and 3-dimensional (3D) data.

Another aspect of the present invention provides a view image providing device and method capable of minimizing image distortion of portions not orthogonally photographed with respect to a face of a 3D object during acquisition of an omnidirectional image, by using an omnidirectional image including margins and by performing rendering by dividing a 3D mesh into smaller meshes.

According to an aspect of the present invention, there is provided a view image providing device including a panorama image generation unit to generate a panorama image using a cube map including a margin area by obtaining an omnidirectional image, a mesh information generation unit to generate 3-dimensional (3D) mesh information that uses the panorama image as a texture by obtaining 3D data, and a user data rendering unit to render the panorama image and the mesh information into user data according to a position and direction input by a user.

The panorama image generation unit may generate the panorama image by 3D converting the omnidirectional image according to directions of faces constituting the cube map.

The panorama image generation unit may perform the 3D conversion based on a parameter of a camera for taking the omnidirectional image, the parameter according to a movement direction of the camera, and a parameter of a virtual camera of the cube map.

The panorama image generation unit may generate the panorama image by mapping the omnidirectional image with faces constituting the cube map according to a predetermined order using a development figure of the cube map.

The margin area which refers to a corner portion of the cube map may include an area showing a part of different cube maps neighboring each other.

The mesh information may include at least one of a vertex coordinate of the 3D mesh and face information of the 3D mesh.

The user data rendering unit may render faces included in the mesh information corresponding to points on the omnidirectional image using a camera matrix according to the position and direction, wherein the camera matrix may include a matrix that calculates a position of a point on the cube map into a position on the omnidirectional image.

The user data rendering unit may render vertices constituting faces of the cube map using a camera for taking the omnidirectional image according to the position and direction.

The view image providing device may further include a user data providing unit to provide the rendered user data to the user.

According to an aspect of the present invention, there is provided a view image providing method including generating a panorama image using a cube map which includes a margin area, by obtaining an omnidirectional image, generating 3-dimensional (3) mesh information that uses the panorama image as a texture by obtaining 3D data, and rendering the panorama image and the mesh information into user data according to a position and direction input by a user.

The the generating of the panorama image may include generates the panorama image by 3D converting the omnidirectional image according to directions of faces constituting the cube map.

The generating of the panorama image may include performing the 3D conversion based on a parameter of a camera for taking the omnidirectional image, the parameter according to a movement direction of the camera, and a parameter of a virtual camera of the cube map.

The generating of the panorama image may include generating the panorama image by mapping the omnidirectional image with faces constituting the cube map according to a predetermined order using a development figure of the cube map.

The margin area may include an area showing a part of different cube maps neighboring each other.

The mesh information may include at least one of a vertex coordinate of the 3D mesh and face information of the 3D mesh.

The rendering into the user data may include rendering faces included in the mesh information corresponding to points on the omnidirectional image using a camera matrix according to the position and direction, wherein the camera matrix may include a matrix that calculates a position of a point on the cube map into a position on the omnidirectional image.

The rendering into the user data may include rendering vertices constituting faces of the cube map using a camera for taking the omnidirectional image according to the position and direction.

The view image providing method may further include a user data providing unit to provide the rendered user data to the user.

### EFFECT

According to embodiments of the present invention, a view image providing device and method are capable of providing a view image smoothly and ceaselessly to a user when providing a service according to a user operation, by rendering an image of a predetermined view using an omnidirectional image and 3-dimensional (3D) data.

Additionally, according to embodiments of the present invention, a view image providing device and method are capable of minimizing image distortion of portions not orthogonally photographed with respect to a face of a 3D object during acquisition of an omnidirectional image, by using an omnidirectional image including margins and by performing rendering by dividing a 3D mesh into smaller meshes.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a view image providing device according to an embodiment of the present invention;

FIG. 2 is a diagram illustrating a detailed structure of a view image providing device according to an embodiment of the present invention;

FIG. 3 is a diagram illustrating a cube map according to an embodiment of the present invention;

FIG. 4 is a diagram illustrating a cube map panorama according to an embodiment of the present invention;

FIG. 5 is a diagram illustrating a cube map including a margin according to an embodiment of the present invention;

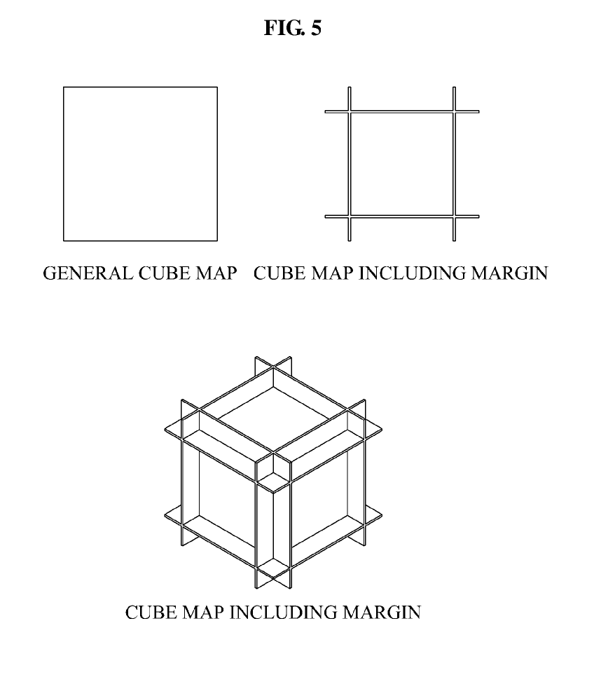

FIG. 6 is a development diagram illustrating a cube map including a margin according to an embodiment of the present invention; and

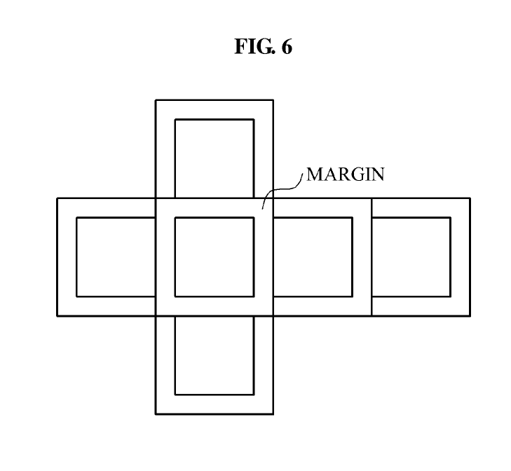

FIG. 7 is a diagram illustrating a view image providing device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

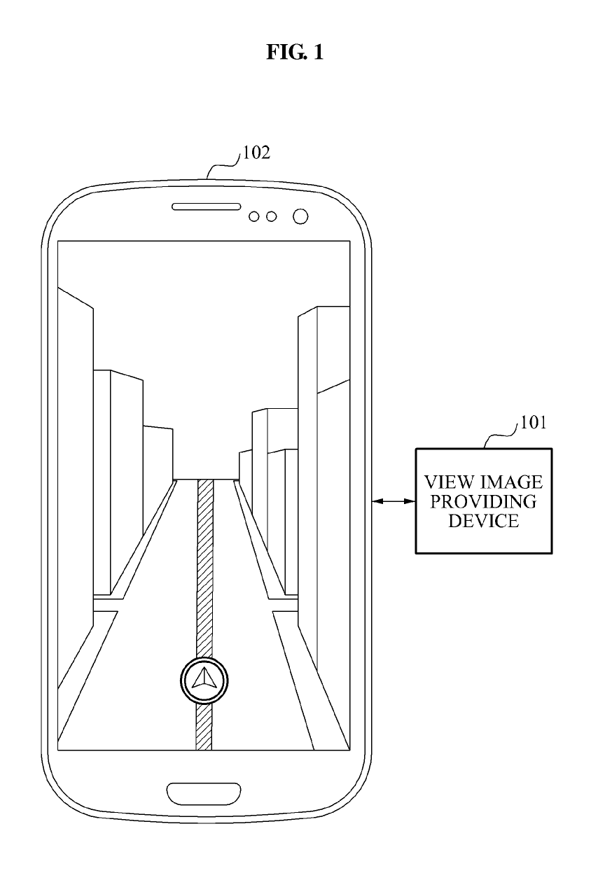

FIG. 1 is a diagram illustrating a view image providing device 101 according to an embodiment of the present invention.

Referring to FIG. 1, the view image providing device 101 may provide a user with user data of a user desired spot according to a position and a direction input from the user. The view image providing device 101 may provide the user data through a user terminal 102. The user may change the position and the direction as desired using the user terminal 102. In addition, the view image providing device 101 may render and provide the user data according to the changed position and direction.

In detail, the view image providing device 101 ay obtain an omnidirectional image of a street or a building to be serviced through a camera fixed to a moving object. The omnidirectional image may be a panorama image including images taken in various angles from one position, thereby providing a wider angle view than general images. In addition, the omnidirectional image may include size images taken in a spherical shape, cylindrical shape, or cube shape, or images constituting a polyhedral shape. Additionally, the view image providing device 101 may store photographing positions and directions of the omnidirectional image using a position sensor.

The view image providing device 101 may obtain the omnidirectional image in various forms such as a cylinder panorama image, a spherical panorama image, a horizontal image, a vertical image, and the like. In addition, the view image providing device 101 may generate a panorama image of a cube map including a margin using the obtained omnidirectional image.

Furthermore, the view image providing device 101 may obtain 3-dimensional (3D) data. The 3D data may be 3D position information for providing the omnidirectional image corresponding to the changed position and direction. Also, the 3D data may be in the form of a large scale point cloud. The view image providing device 101 may generate 3D mesh information that uses a panorama image as a texture, using the obtained 3D data.

For example, the view image providing device 101 may use a laser scanner capable of obtaining the 3D position information, besides the camera fixed to the moving object, to obtain the 3D data. In addition, the view image providing device 101 may convert the 3D data into a 3D mesh used in graphic since the 3D data is difficult to be applied to direct rendering and inefficient for network transmission due to the data size.

The view image providing device 101 may render the panorama image generated according to the position and direction input by the user and the 3D mesh information into user data. In addition, the view image providing device 101 may provide the rendered user data to the user through the user terminal 102.

In addition, the view image providing device 101 may include a server for storing the omnidirectional images of the street or building to be serviced, and the 3D data in the form of the mesh. Also, the view image providing device 101 may provide an interface for providing a view image through the user terminal 102. The view image providing device 101 may be input with a view position and direction desired by the user through the user terminal 102. The user desired view position and direction may be calculated and transmitted to the server by the view image providing device 101. The server may transmit the omnidirectional image according to the calculated view position and direction, the 3D data, and 3D geometrical information to the view image providing device 101. The 3D geometrical information may include the photographing position and direction of the obtained omnidirectional image. The view image providing device 101 may render and provide the user data corresponding to the view position and direction input through the user terminal 102. The user may manipulate the view of the user data being provided. The view image providing device 101 may render and provide the user data again according to the user manipulation. When data of another position is necessary due to a change in the view position, the view image providing device 101 may request the server for the data of another position and receive user data corresponding to the data request.

The view image providing device 101 may render an image of a predetermined view using the omnidirectional image and the 3D data, thereby providing a view image smoothly and ceaselessly when providing the service according to the user manipulation.

The view image providing device uses the omnidirectional image including the margin and renders the image by dividing 3D mesh into small meshes. Therefore, distortion of the image at portions not orthogonally photographed with respect to a 3D object face may be minimized during acquisition of an omnidirectional image.

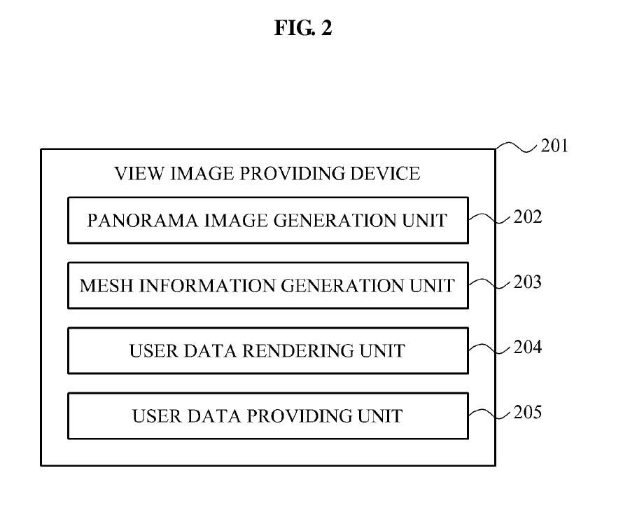

FIG. 2 is a diagram illustrating a detailed structure of a view image providing device 201 according to an embodiment of the present invention.

Referring to FIG. 2, the view image providing device 201 may include a panorama image generation unit 202, a mesh information generation unit 203, a user data rendering unit 204, and a user data providing unit 205.

The panorama image generation unit 202 may obtain an omnidirectional image and generate a panorama image using a cube map including a margin. Here, the panorama image may include a margin. The panorama image generation unit 202 may generate the panorama image by 3D converting the omnidirectional image according to directions of faces constituting the cube map. The cube map may refer to a method of storing the omnidirectional image using a cube map panorama in which margins intercross in a crosshatch manner.

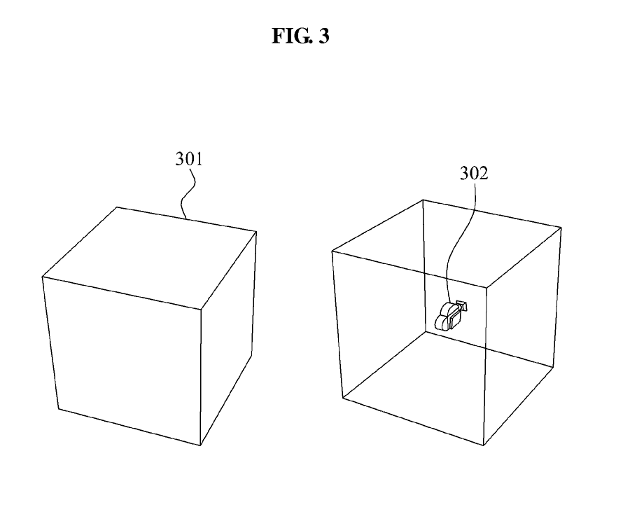

The panorama image generation unit 202 may convert the omnidirectional image into a plurality of images in the cube map form. The panorama image generation unit 202 may generate the panorama image by storing the omnidirectional image corresponding to the directions of the faces of the cube map being in a cube shape. In general, the panorama image generation unit 202 may generate the panorama image presuming that a virtual camera is disposed in a center of the cube. Here, the panorama image generation unit 202 may generate the panorama image using other methods than the foregoing methods. The case in which the virtual camera is disposed in the center of the cube will be described in detail with reference to FIG. 3.

The mesh information generation unit 203 may generate the 3D mesh information that uses the panorama image as a texture, by obtaining the 3D data. The mesh information generation unit 203 may be a large scale point cloud type that converts the 3D data, which is inconvenient for transmission and rendering, into the 3D mesh. For example, the mesh information generation unit 203 may automatically convert the 3D data into the 3D mesh using a computer. In addition, the mesh information generation unit 203 may manually convert the 3D data by referencing a point cloud from an administrator capable of converting the 3D data into the 3D mesh. Also, the mesh information generation unit 203 may perform the conversion by calculating a 3D object related to the point cloud of a selected area using part of a point selected by the administrator, semiautomatically by the computer.

In addition, the mesh information generation unit 203 may obtain positions of vertices by performing render by dividing the 3D mesh into small triangles on the texture, using the panorama image as the texture. Each face of the 3D mesh may restrict a size of the triangles with reference to a predetermined value and may be divided variably according to a distance from the view to the face. When the size of the divided face is reduced, a number of the triangles is increased, thereby reducing a rendering speed. When the size of the divided face is increased, triangles that cannot be rendered are not generated. Therefore, the mesh information generation unit 203 needs to use proper values depending on cases.

In addition, the mesh information generation unit 203 may reduce a perspective distortion which may be generated during calculation of a linear texture coordinate, by rendering by dividing the 3D mesh into small triangles. Therefore, the mesh information generation unit 203 may use the panorama image as the texture of the 3D data.

The mesh information may be in a triangle mesh type which includes a vertex coordinate and face information but does not include the texture coordinate.

The user data rendering unit 204 may render the panorama image and the mesh information into the user data according to the position and direction input by the user.

The user data rendering unit 204 may perform 3D rendering with respect to the mesh information of a pre-divided triangle at a view according to the position and direction input by the user. Here, the user data rendering unit 204 may use the panorama image of the omnidirectional image as the texture. The user data rendering unit 204 may designate a texture coordinate by corresponding respective faces of the mesh information to points on the panorama image using a camera matrix. The camera matrix may refer to a matrix capable of calculating a position of a point on a 3D space into a position on an image taken by a camera.

The user data rendering unit 204 may convert vertices included in the faces into coordinates on the panorama image using a camera parameter of each panorama image. Additionally, the user data rendering unit 204 may identify presence or absence of the panorama image including all vertices included in the panorama image of respective faces. When the panorama image is present, the user data rendering unit 204 may use the panorama image as the texture. When the panorama image is absent, the user data rendering unit 204 may render the face. Accordingly, the view image providing device 201 may control set values of small triangles divided from the 3D mesh so that the triangles may be rendered, thereby using the panorama image as the texture.

The user data rendering unit 204 may check the positions of the vertices included in the panorama image using a following method. Here, therefore, the user data rendering unit 204 may project the vertices constituting the face onto the panorama image to check whether the vertices are included in the face.

It may be presumed that c denotes one of a plurality of panorama images constituting the cube map. M_c may denote the camera matrix, and v may denote the coordinate of one vertex included in the mesh information. In this case, when the position of the vertex is projected onto a panorama image c, the coordinate may be calculated by Equation 1.

v_{—}c=M_{—}c*v [Equation 1]

v_{—}c=(x_{—}c, y_{—}c, z_{—}c) [Equation 2]

Also, the user data rendering unit 204 may identify a position of the vertex present on the panorama image c based on Equation 2. Here, the position of the vertex may be expressed by Equation 3.

(x_c/z_c, y_c/z_c) [Equation 3]

The user data rendering unit 204 may extract the coordinate on the texture, by projecting every vertex constituting one face to every panorama image of the cube map. The user data rendering unit 204 may determine whether the face is included in every panorama image of the cube map using the extracted coordinate on the texture.

Here, since each face of the 3D data is divided into small triangles for rendering, the user data rendering unit 204 may use three vertices when projecting to the panorama image.

The user data rendering unit 204 performs rendering by generating a building object according to the vertex coordinate on the texture projected to the panorama image. Therefore, the user data rendering unit 204 may generate a virtual space by rendering the user data according to the position and direction input by the user.

The user data providing unit 205 may provide the user with the rendered user data through a user terminal.

FIG. 3 is a diagram illustrating a cube map according to an embodiment of the present invention.

Referring to FIG. 3, a method of generating a panorama image when a virtual camera 302 is disposed in a center of a cube will be described.

A view image providing device may generate the panorama image by 3D converting an omnidirectional image according to directions of faces constituting a cube map 301. In detail, the view image providing device may convert the omnidirectional image into six images in a cube map form. The view image providing device may generate the panorama image by storing the omnidirectional image corresponding to the directions of the faces constituting the cube including six faces.

The view image providing device may presume that the camera 302 taking the omnidirectional image is disposed in the center of the cube formed by the cube map 301, and thereby generate the panorama image through 3D conversion of the omnidirectional image.

The 3D conversion may be performed using relationships between a camera parameter of the omnidirectional image and a parameter of the camera 302 presumed to be in the cube map 301. In detail, the cube map 301 may calculate the camera parameter per each of six parameter images constituting the cube map. Here, the view image providing device may calculate the camera parameter using fixed relationships between the cube map and the parameter images in the cube. Therefore, the view image providing device may calculate the camera parameter of every panorama image of the cube map based on the camera parameter with respect to an advancing direction of the omnidirectional image.

The view image providing device may perform 3D conversion according to the relationships between the camera parameter of the omnidirectional image and the parameter of the camera 302 presumed as the cube map 301, thereby generating the omnidirectional image.

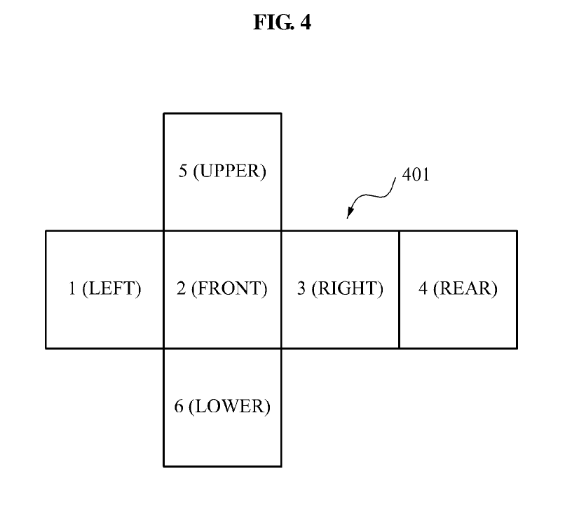

FIG. 4 is a diagram illustrating a cube map panorama according to an embodiment of the present invention.

Referring to FIG. 4, a development diagram of a cube map is shown.

A view image providing device may generate a panorama image by 3D converting an omnidirectional image according to an order and direction as shown in FIG. 4.

The view image providing device may use a cube map panorama in which margins of the omnidirectional image intercross in a crosshatch manner. The cube map panorama may include a plurality of images, that is, a front, rear, left, right, upper, and lower images. In addition, the cube map panorama may include the margin as a corner portion of each panorama image. The margin may refer to a portion included simultaneously in at least two images, expanded from an area allocated around a boundary of a divided image when the omnidirectional image is formed to the cube map. A size of the margin may be determined by the user.

The order and direction of the panorama image of the view image providing device may not be limited to the foregoing description. The panorama image may be generated by 3D converting the omnidirectional image in various manners.

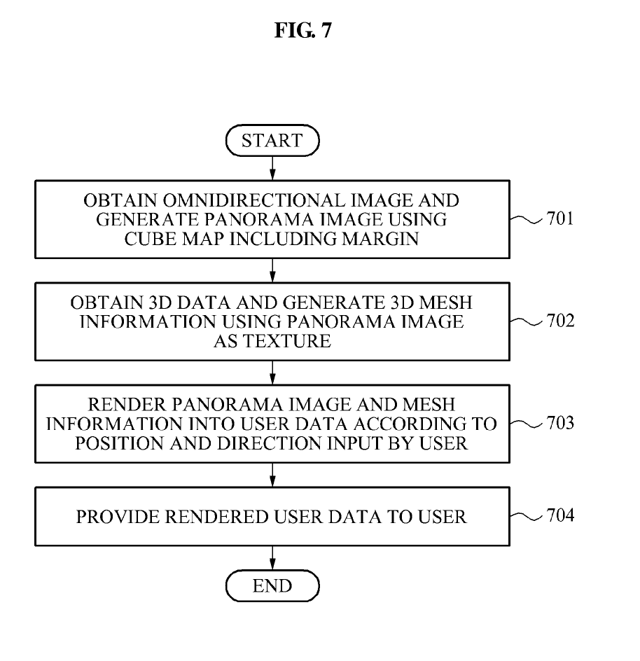

FIG. 7 is a diagram illustrating a view image providing device according to an embodiment of the present invention.

In operation 701, the view image providing device may generate a panorama image using a cub map including a margin, by obtaining an omnidirectional image. The view image providing device may generate the panorama image by 3D converting the omnidirectional image according to directions of faces constituting the cube map. The view image providing device may perform the 3D conversion through the relationships between a camera parameter of the omnidirectional image and a parameter of a camera presumed to be in the cube map.

The view image providing device may convert the omnidirectional image into a plurality of images in the form of the cube map. The view image providing device may generate the panorama image by storing the omnidirectional image corresponding to the directions of the faces of the cube map being in a cube shape. Also, in general, the view image providing device may generate the panorama image by presuming that a virtual camera is disposed in a center of of the cube shape.

The view image providing device may calculate a camera matrix directed to a front using 3D geometrical information according to a position and direction in which the omnidirectional image is obtained. The view image providing device may extract a matrix product with respect to camera matrices of different cameras from the camera matrix of the camera directed to the front, using fixed relationships between cameras directed to the faces of the panorama image and the camera directed to the front.

In operation 702, the view image providing device may generate 3D mesh information that uses the panorama image as a texture, by obtaining 3D data. The view image providing device may be a large scale point cloud type that converts the 3D data, which is inconvenient for transmission and rendering, into the 3D mesh. In addition, the view image providing device may obtain positions of vertices by rendering by dividing the 3D mesh on the texture into small triangles, using the panorama image as the texture. A size of the divided faces of the 3D mesh may restrict a size of the triangles with reference to a predetermined value and the faces of the 3D mesh may be divided variably according to a distance from a view to the face. The mesh information may be a triangle mesh type which includes a vertex coordinate and face information but does not include the texture coordinate.

In operation 703, the view image providing device may render the panorama image and the mesh information into user data, according to the position and direction input by the user. The view image providing device may perform 3D rendering with respect to the mesh information of a pre-divided triangle at a view according to the position and direction input by the user. Here, the view image providing device may use the panorama image of the omnidirectional image as the texture. In addition, the view image providing device may designate a texture coordinate by corresponding the faces of the mesh information to points on the panorama image using a camera matrix.

The view image providing device may convert the vertices included in the faces into coordinates on the panorama image, using the camera parameter of each panorama image. The view image providing device may identify presence or absence of the panorama image including the all vertices included in the panorama image of the faces. In addition, the view image providing device may generate a virtual space by rendering the user data according to the input position and direction, by generating a building object according to the vertex coordinate on the texture projected to the panorama image.

In operation 704, the view image providing device may provide the rendered user data to the user through a user terminal.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A view image providing device comprising:
a panorama image generation unit to generate a panorama image using a cube map including a margin area by obtaining an omnidirectional image;
a mesh information generation unit to generate 3-dimensional (3D) mesh information that uses the panorama image as a texture by obtaining 3D data; and
a user data rendering unit to render the panorama image and the mesh information into user data according to a position and direction input by a user.

2. The view image providing device of claim 1, wherein the panorama image generation unit generates the panorama image by 3D converting the omnidirectional image according to directions of faces constituting the cube map.

3. The view image providing device of claim 2, wherein the panorama image generation unit performs the 3D conversion based on a parameter of a camera for taking the omnidirectional image, the parameter according to a movement direction of the camera, and a parameter of a virtual camera of the cube map.

4. The view image providing device of claim 1, wherein the panorama image generation unit generates the panorama image by mapping the omnidirectional image with faces constituting the cube map according to a predetermined order using a development figure of the cube map.

5. The view image providing device of claim 1, wherein the margin area which refers to a corner portion of the cube map comprises an area showing a part of different cube maps neighboring each other.

6. The view image providing device of claim 1, wherein the mesh information comprises at least one of a vertex coordinate of the 3D mesh and face information of the 3D mesh.

7. The view image providing device of claim 1, wherein the user data rendering unit renders faces included in the mesh information corresponding to points on the omnidirectional image using a camera matrix according to the position and direction,
wherein the camera matrix includes a matrix that calculates a position of a point on the cube map into a position on the omnidirectional image.

8. The view image providing device of claim 1, wherein the user data rendering unit renders vertices constituting faces of the cube map using a camera for taking the omnidirectional image according to the position and direction.

9. The view image providing device of claim 1, further comprising a user data providing unit to provide the rendered user data to the user.

10. A view image providing method comprising:
generating a panorama image using a cube map which includes a margin area, by obtaining an omnidirectional image;
generating 3-dimensional (3D) mesh information that uses the panorama image as a texture by obtaining 3D data; and
rendering the panorama image and the mesh information into user data according to a position and direction input by a user.

11. The view image providing method of claim 10, wherein the generating of the panorama image comprises generates the panorama image by 3D converting the omnidirectional image according to directions of faces constituting the cube map.

12. The view image providing method of claim 11, wherein the generating of the panorama image comprises performing the 3D conversion based on a parameter of a camera for taking the omnidirectional image, the parameter according to a movement direction of the camera, and a parameter of a virtual camera of the cube map.

13. The view image providing method of claim 10, wherein the generating of the panorama image comprises generating the panorama image by mapping the omnidirectional image with faces constituting the cube map according to a predetermined order using a development figure of the cube map.

14. The view image providing method of claim 10, wherein the margin area comprises an area showing a part of different cube maps neighboring each other.

15. The view image providing method of claim 10, wherein the mesh information comprises at least one of a vertex coordinate of the 3D mesh and face information of the 3D mesh.

16. The view image providing method of claim 10, wherein the rendering into the user data comprises rendering faces included in the mesh information corresponding to points on the omnidirectional image using a camera matrix according to the position and direction,
wherein the camera matrix includes a matrix that calculates a position of a point on the cube map into a position on the omnidirectional image.

17. The view image providing method of claim 10, wherein the rendering into the user data comprises rendering vertices constituting faces of the cube map using a camera for taking the omnidirectional image according to the position and direction.

18. The view image providing method of claim 10, further comprising a user data providing unit to provide the rendered user data to the user.
